(19) United States
(12) Patent Application Publication
(10) Pub. No.: US 2014/0329649 A1
(43) Pub. Date: Nov. 6, 2014

(54) Rehabilitation Flexor

(71) Applicant: Michael Boutros, No. Arlington, NJ (US)

(72) Inventor: Michael Boutros, No. Arlington, NJ (US)

(21) Appl. No.: 14/270,615

(22) Filed: May 6, 2014

Related U.S. Application Data
(60) Provisional application No. 61/899,501, filed on Nov. 4, 2013.
(60) Provisional application No. 61/819,768, filed on May 6, 2013.

(51) Int. Cl. A61H 1/00; A63B 21/00

(52) U.S. Cl. CPC A61H 1/008; A63B 21/00003
USPC 482/131

(57) ABSTRACT

The present disclosure describes a rehabilitation flexor having a center piece and two twisting assemblies. The center piece may include a top section, a bottom section, and a curved section longitudedly connected to form a continuous body partially surrounding a leg recess, which is configured to accommodate a human leg behind the knee. Each twisting assembly has at least a handle bar that can be held by the user and used to manipulate the rehabilitation flexor. The rehabilitation flexor may be used to improve the rehabilitation and recovery of a person's leg mobility and flexibility after injury or surgery. In one alternate embodiment, the center piece and twisting assemblies are one piece formed from an injection molding or similar process. In this alternate embodiment, the leg recess has a padded covering such as memory foam to help support and cushion the user.

### CLAIM OF PRIORITY

This application claims priority to U.S. Application Ser. No. 61/819,768 filed on May 6, 2013 and U.S. Application Ser. No. 61/899,501 filed on Nov. 4, 2013, the contents of both of which are herein fully incorporated by reference in their entirety.

### FIELD OF THE INVENTION

The current invention relates to device designed for physical rehabilitation and recovery. In particular, the current invention relates to a flexor that may be used for rehabilitation and recovery of hip, knee, and other joints after injury and/or surgery

### BACKGROUND OF THE INVENTION

During work and sport activities, sometime people injure their knee, hip, or other joints such as ankles or wrists. Some of the injuries may be cured by resting and physical therapy; some may require surgery. No matter what the treatment is, rehabilitation and recovery are crucial processes that help a person to regain full mobility. It is thus desirable to have medical devices or apparatus that facilitate rehabilitation and recovery, improve the treatments, and help to obtain better results. Various kinds of devices have been developed to fit the needs of different persons and different rehabilitation requirement. However, these devices share fundamental shortcomings for failing to improve some particular motions during rehabilitation and recovery.

One example of the existing apparatus is the disclosure from US Pat. Pub. No. 2011/0224585 ('585 publication) which teaches “a knee rehabilitation device which can be used in various stages of knee rehabilitation to facilitate a full range of knee motion and promote joint flexibility following a knee impairment.” In addition, “the device, which can be can be used by a patient with or without the aid of medical personnel, is simple to use, and is highly adjustable to accommodate different therapy regimens, and different leg sizes. To achieve maximum stretch of affected tissues of a pathologic joint, the device can be used without the need of lower extremity muscle involvement. A first embodiment device is machined or cast from a lightweight structural metal, such as titanium, aluminum or magnesium. The device includes a handle of adjustable length that is rotatably coupled to a parallel-beam leg support. The leg support provides attachment points for multiple adjustable slings that bridge the gap between the parallel beams.” Abstract, '585 Publication.

The invention disclosed by the '585 Publication, as well as a number of other devices, though claimed to “facilitate a full range of knee motions,” actually focuses mainly on the bending/relaxing motion of the knee without addressing other motions that are important to full leg recovery. For example, one often ignored aspect is the “abduction” motions of the hip—the inward and outward (or internal and external) twisting of the hip, which are very important to full functional recovery such as walking and running. The disclosure of the '585 Publication, as well as the teaching from a number of other inventions, fails to address this need. The device taught by the current invention, on the other hand, deals with such mostly-ignored motions with a simple and effective design.

In summary, various apparatus are known in the art, but their structures are distinctively different from the current invention. Moreover, the other inventions fail to address all of the problems solved by the invention described herein. One embodiment of this invention is illustrated in the accompanying drawings and will be described in more detail herein below.

### SUMMARY OF THE INVENTION

The current invention discloses a rehabilitation flexor, comprising: a center piece including two connecting rods, a top section, a bottom section, and a curved section, the top section and the bottom section longitudedly connecting to the curved section, forming a continuous body partially surrounding a leg recess and having an interior, an exterior, and a center piece opening providing lateral access to the leg recess; and two twisting assemblies, each twisting assembly having a straight bar connected to a handle bar, wherein the leg recess is configured to have a contour that accommodate a human leg behind the knee, each connecting rod attaches a straight bar of a twisting assembly to the center piece, the center piece is mirror symmetric, and the two twisting assemblies are mirror symmetric.

In terms of structure, while the top section and the bottom section are preferably partial cylindrical shapes that are longitudedly straight, the curved section is a partial cylindrical shape that is longitudedly curved. The openings on the top section, the bottom section, and the curved section are connected to form the center piece opening, which allows a human leg to be inserted laterally into the leg recess.

The rehabilitation device may be used in various manners. In the most common approach, the user sits on a chair, positions her/her leg in the leg recess with the center piece fitting behind the knee, takes hold of the handles with both hands, and twists the twisting assemblies so that the user's leg may be twisted to mimic the abduction motion for the hip. This routine helps to rehabilitate the user's hip in a full capacity. In addition, there are other ways to use the rehabilitation device herein disclosed.

The rehabilitation flexor may have additional structures to facilitate its use. For example, while the center piece may have center piece edges aligning the center piece opening, there may be through holes on the center piece positioned along the center piece edges, and the through holes are paired one against another. Fastening straps may be used to secure the center piece to a user's leg, wherein each strap links a pair of through holes positioned against each other. Moreover, to prevent slipping, there may be handle bar covers covering the handle bar and straight bar covers covering the straight bar.

Preferably, the rehabilitation flexor is made from robust and durable material. For example, the center piece may be made from hard plastic such as PVC and the twisting assemblies may be made from light metal such as aluminum. Moreover, it is also desirable that the rehabilitation flexor is overall light and portable, allowing the user or his/her helper to conveniently carry the device around.

In general, the present invention succeeds in conferring the following, and others not mentioned, desirable and useful benefits and objectives.

It is an object of the present invention to provide a rehabilitation flexor that allows the user to use the device while sitting or lying.

It is an object of the present invention to provide a rehabilitation flexor that is light and portable.

It is another object of the current invention to provide a rehabilitation flexor that may be used for different persons having different physical parameters.

It is still another object of the current invention to provide a rehabilitation flexor that allows easy adjustment of the twisting assemblies.

It is another object of the current invention to provide a rehabilitation flexor that may be used to improve the abduction motion of the hip.

It is yet another object of the current invention to provide a rehabilitation flexor that includes interior pad for comfort and better fit.

It is another object of the current invention to provide a rehabilitation flexor that is inexpensive.

It is yet another object of the current invention to provide a rehabilitation flexor that is durable and robust.

It is another object of the current invention to provide a rehabilitation flexor that is includes anti-slippery covers.

It is yet another object of the current invention to provide a rehabilitation flexor that is easy to use and easy to manufacture.

### BRIEF DESCRIPTION OF THE DRAWINGS

FIG. 1A shows a front perspective view of a preferred embodiment of the rehabilitation flexor.

FIG. 1B shows a front view of a preferred embodiment of the rehabilitation flexor.

FIG. 2 shows a back perspective view of a preferred embodiment of the rehabilitation flexor.

FIG. 3 shows a back view of a preferred embodiment of the rehabilitation flexor when the center piece and the twisting assemblies are disconnected.

FIG. 4 shows a side view of a preferred embodiment of the rehabilitation flexor.

FIG. 5 shows a front perspective view of a preferred embodiment of the rehabilitation flexor when the rehabilitation flexor is in use.

FIG. 6 shows a front view of an alternate embodiment of a rehabilitation flexor.

FIG. 7 shows a rear perspective view of an alternate embodiment of a rehabilitation flexor.

FIG. 8 shows a side view of an alternate embodiment of a rehabilitation flexor.

FIG. 9 shows is a front view of a second alternate embodiment of a rehabilitation flexor.

### DESCRIPTION OF THE PREFERRED EMBODIMENTS

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

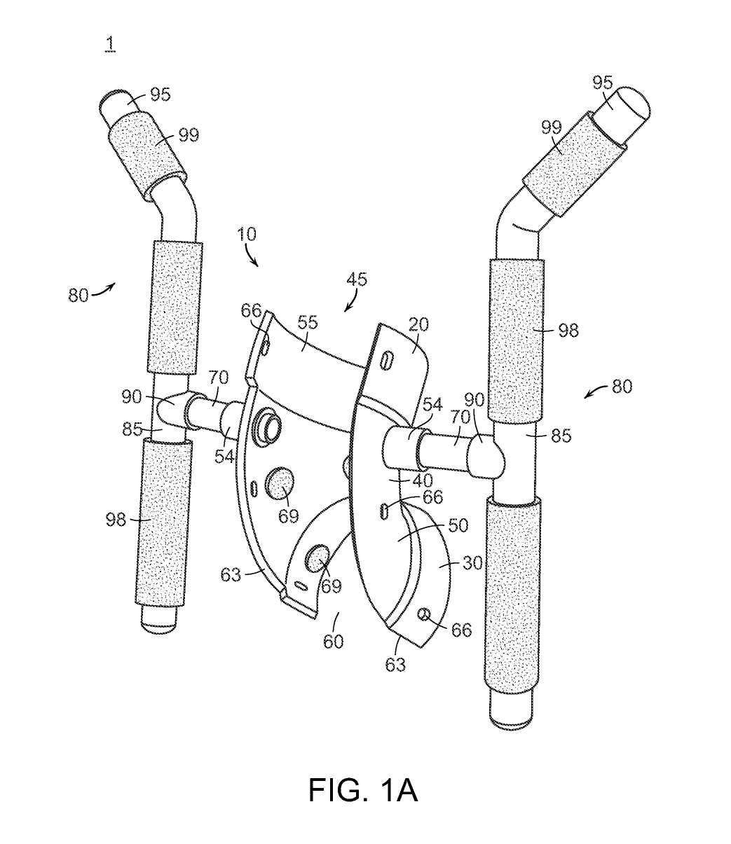

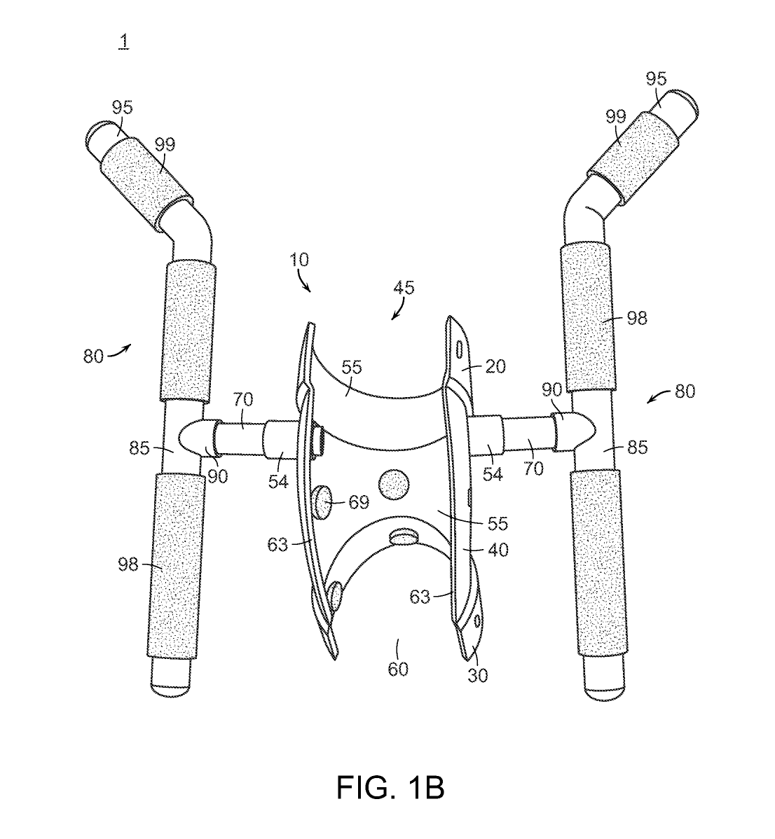

FIG. 1A shows a front perspective view of a preferred embodiment of the rehabilitation flexor. Shown in FIG. 1A is the rehabilitation flexor 1 having a center piece 10 and two twisting assemblies 80, wherein the center piece 10 includes two connecting rods 70 linking the twisting assemblies 80 to the center piece 10. The center piece 10 includes a top section 20, a bottom section 30, and a curved section 40 longitudedly connected and forming a continuous body partially surrounding a leg recess 45, the continuous body having an interior 55, an exterior 50, and a center piece opening 60 aligned by center piece opening edges 63, wherein the center piece opening 60 provides lateral access to the leg recess 45. On the top section 20, the curved section 40, and the bottom section 30, there are through holes 66 positioned close to the center piece opening edges 63, wherein the through holes are paired one against another. Also shown in FIG. 1A are two first receiving tubes 54 attached to the curved section and a plurality of center piece interior pads 69 attached to the interior 55 of the leg recess 45. Each twisting assembly 80 includes a straight bar 85 and a handle bar 95 connected to the straight bar 85. Each twisting assembly 80 also includes a second receiving tube 90 which may receive the connecting rod 70, together with the first receiving tube 54. Whereas there are straight bar covers 98 covering the straight bars 85, there are handle bar covers 99 covering the handle bars 95. For clarity purposes, not all the same elements are marked. E.g. the through holes 66.

FIG. 1B shows a front view of a preferred embodiment of the rehabilitation flexor. Shown in FIG. 1B is rehabilitation flexor 1 having a center piece 10 and two twisting assemblies 80, wherein the center piece 10 includes two connecting rods 70 linking the twisting assemblies 80 to the center piece 10. The center piece 10 includes a top section 20, a bottom section 30, and a curved section 40 longitudedly connected and forming a continuous body partially surrounding a leg recess 45, the continuous body having an interior 55, an exterior 50, and a center piece opening 60 aligned by center piece opening edges 63, wherein the center piece opening 60 provides lateral access to the leg recess 45. On the top section 20, the curved section 40, and the bottom section 30, there are through holes 66 positioned close to the center piece opening edges 63, wherein the through holes are paired one against another. Also shown in FIG. 1B are two first receiving tubes 54 attached to the curved section and a plurality of center piece interior pads 69 attached to the interior 55 of the leg recess 45. Each twisting assembly 80 includes a straight bar 85 and a handle bar 95 connected to the straight bar 85. Each twisting assembly 80 also includes a second receiving tube 90 which may receive the connecting rod 70, together with the first receiving tube 54. Whereas there are straight bar covers 98 covering the straight bars 85, there are handle bar covers 99 covering the handle bars 95. For clarity purposes, not all the same elements are marked.

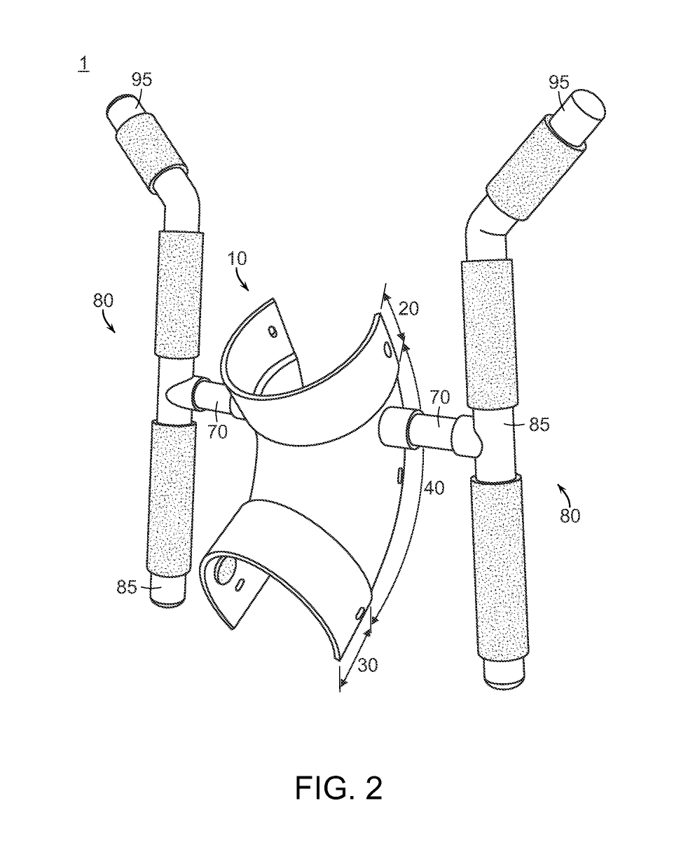

FIG. 2 shows a back perspective view of a preferred embodiment of the rehabilitation flexor. Shown in FIG. 2 is rehabilitation flexor 1 having a center piece 10 and two twisting assemblies 80, wherein the center piece 10 includes two connecting rods 70 linking the twisting assemblies 80 to the center piece 10. The center piece 10 includes a top section 20, a bottom section 30, and a curved section 40 longitudedly connected and forming a continuous body. Each twisting assembly 80 includes a straight bar 85 and a handle bar 95 connected to the straight bar 85.

Referring to FIGS. 1A, 1B, and 2, while the top section 20 and the bottom section 30 are preferably partial cylindrical structures that are longitudedly straight, the curved section 40 is a preferably partial cylindrical structure that is longitudedly curved. The top section 20 and the bottom section 30 are connected to the two ends of the curved section 40. The openings on the top section 20, the bottom section 30, and the curved section 40 are connected to form the center piece opening 60, which allows a human leg to be inserted laterally into the leg recess 45. Preferably, not only the center piece is minor symmetric, but also the two twisting assemblies are minor symmetric.

The center piece interior pads 69 may serve two purposes: (1) to adjust how the leg recess 45 fits a human leg; and (2) prevent slipping between the center piece 10 and the leg to ensure effectiveness of the rehabilitation device. The center piece interior pads 69, though shown as round pads in the figures, may take any shape or thickness. For example, the center piece interior pads 69 may be rectangular strips attached to the interior 55 of the leg recess 45.

The through holes 66 are paired and positioned close to the center piece opening edges 63. These through holes 66 may be used to allow the attachment of straps for further fastening.

Normally, it is not necessary to have additional strap because the center piece may fit the user's leg closely and may be affixed between the user's leg and the chair. However, sometimes it may require additional fastening mechanisms, wherein straps may be added to the rehabilitation device for better results.

The straight bar cover 98 and the handle bar cover 99 are mainly used to prevent slipping and improve safety of the device. In addition, the bar covers 98 and 99 may also provide cushioning and comfort to the user. The pattern, design, and thickness of the bar covers 98 and 99 may vary from what is shown in FIGS. 1A, 1B, and 2.

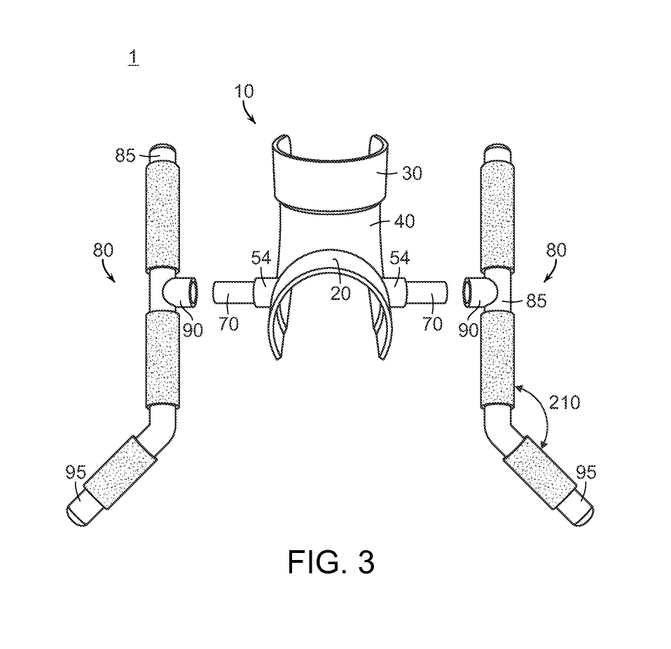

FIG. 3 shows a back view of a preferred embodiment of the rehabilitation flexor when the center piece and the twisting assemblies are disconnected. Shown in FIG. 3 is rehabilitation flexor 1 having a center piece 10 and two twisting assemblies 80, wherein the center piece 10 includes two connecting rods 70 linking the twisting assemblies 80 to the center piece 10. The center piece 10 includes a top section 20, a bottom section 30, and a curved section 40 longitudedly connected and forming a continuous body. Also shown in FIG. 3 are two first receiving tubes 54 attached to the curved section. Each twisting assembly 80 includes a straight bar 85 and a handle bar 95 connected to the straight bar 85. Each twisting assembly 80 also includes a second receiving tube 90 which is capable of receiving the connecting rod 70 extended from the first receiving tube 54. Here in FIG. 3, the second receiving tubes 90 are disconnected from the connecting rods 70, separating the center piece 10 and the twisting assemblies 80.

As shown in FIGS. 3, the center piece 10 and the twisting assemblies 80 may be disconnected for better transportation and storage. The connecting rods may removably or permanently attach the twisting assemblies 80 to the center piece 10. Here removable attachment means that detachment will not cause physical damages to the components; permanent attachment indicates that the detachment will cause damages. While removable attachment allows better adjustment, permanent attachment probably results in a more robust overall structure.

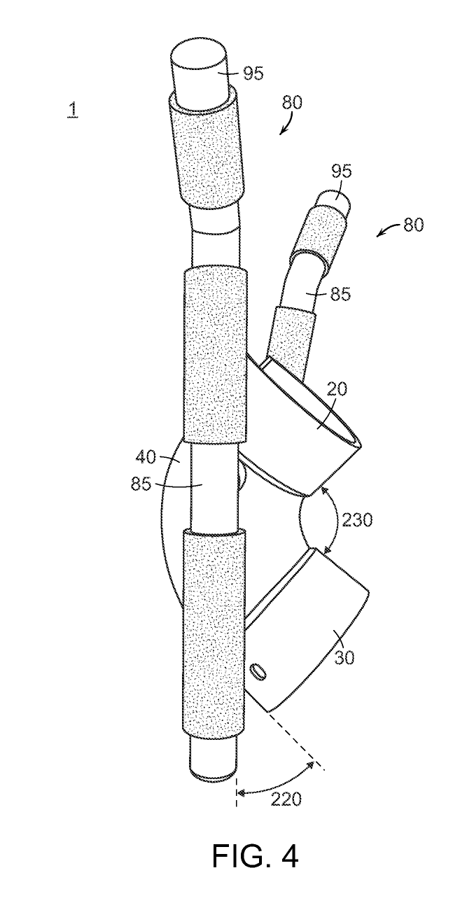

FIG. 4 shows a side view of a preferred embodiment of the rehabilitation flexor. Shown in FIG. 4 is rehabilitation flexor 1 having a center piece 10 and two twisting assemblies 80, wherein the center piece 10 includes two connecting rods 70 (not shown in FIG. 4) linking the twisting assemblies 80 to the center piece 10. The center piece 10 includes a top section 20, a bottom section 30, and a curved section 40 longitudedly connected and forming a continuous body. While the top section 20 and the bottom section 30 are preferably partial cylindrical structures that are longitudedly straight, the curved section 40 is a preferably partial cylindrical structure that is longitudedly curved. Also shown in FIG. 4 are two first receiving tubes 54 attached to the curved section 40. Each twisting assembly 80 includes a straight bar 85 and a handle bar 95 connected to the straight bar 85. Each twisting assembly 80 also includes a second receiving tube 90, which may receive the connecting rod 70, together with the first receiving tube 54.

Referring to FIGS. 3 and 4, the handle bar 95 and the straight bar 85 form a first angle 210; the straight bar 85 and the bottom section 30 form a second angle 220 (from a side view); the top section 20 and the bottom section 30 form a third angle 230. These three angles may affect the functionality of the rehabilitation flexor. The first angle 210 may range from 90 to 180 degrees, with a preferred range of 110 to 160 degrees. The second angle 220 may range from 0 to 180 degrees, measured from the straight bar 85 to the bottom section 30 or from the bottom section 30 to the straight bar 85, with a preferred range of 30 to 120 degrees. The third angle 230 may range from 0 to 180 degrees, with a preferred range of 45 to 135 degrees.

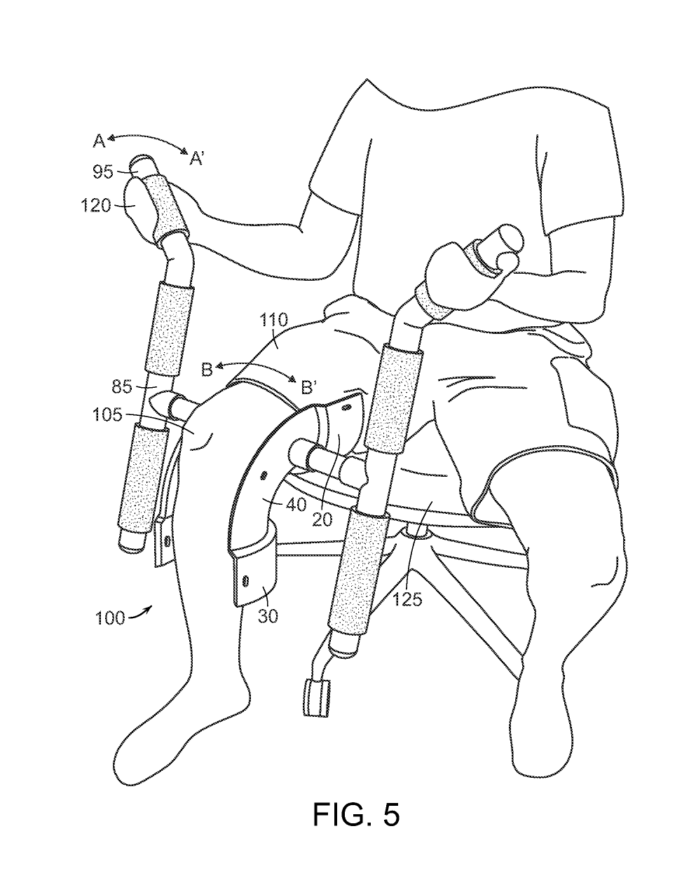

FIG. 5 shows a front perspective view of a preferred embodiment of the rehabilitation flexor when the rehabilitation flexor is in use. In FIG. 5, the user of the rehabilitation flexor inserts his/her leg 100 laterally through the center piece opening and positions his leg 100 into the leg recess, with the curved section 40 of the center piece being positioned at the back of the user's leg behind the knee 105, and the top section 20 being positioned between the user's hip 110 and a sitting surface 125. Here the straight bars 85 are generally parallel or close to parallel to the bottom section 30. The user's hands 120 take hold of the handle bar 95 and swing the twisting assemblies in the directions marked by A-A′, twisting the center piece and the user's hip 110 in the directions marked by B-B′.

The posture shown in FIG. 5 illustrates the most important method the current rehabilitation flexor may be used. This approach allows the user to exercise and enhance the abduction motions (or external and internal rotation) of the hips, resulting in better recover from an injury or surgery. However, it should be noted that the rehabilitation flexor may be used in other postures and exercising routines. For example, in one posture, the user lies on a surface, inserts his/her leg into the leg recess, holds one straight bar, tilt his/her leg up and flexes the hip inward; the user may then pull the straight bar to stretch his/her hip. In another posture, the user lies on a surface, inserts his/her leg into the leg recess, holds both handle bards, tilt his/her leg up and pull the flexor to stretch the hamstring for better recovery and rehabilitation.

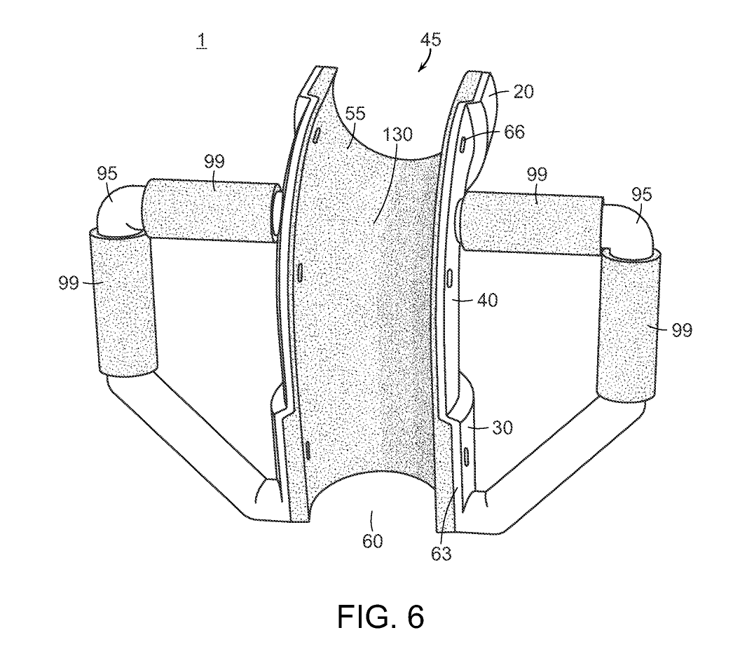

Referring to FIG. 6 there is an alternate embodiment of the rehabilitation flexor 1. Here, the most noticeable difference is in the change of the twisting assemblies 80 to a singularly formed handle bar 95 for each side of the rehabilitation flexor 1. The handle bar 95 is now an extension that is initially perpendicular to the center piece 10. The handle bar cover 99 is disposed on this section, as this is now used primarily for holding and manipulating the rehabilitation flexor 1. The handle bar 95 is preferably now a singular piece formed through a process such as injection molding. The handle bar cover 99 is also disposed over the straight area at about a 90° to the perpendicular area, as this area may be held and used in the alternative depending on the exercise or rehabilitation process being employed. The final section of the handle bar 95 attaches to the bottom section 30. There may be no seam at either of the attachment points as the handle bars 95 and center piece 10 can all be formed in one continuous piece.

The center piece 10 also has a padded covering 130 running the entire interior length of the center piece 10. This padded covering 130 is preferably a memory type foam such as a low resilience polyurethane foam or the like. Alternatively, it may comprise any number of foams, rubberized padding, or covered felt, down, feathers, or any combination thereof. The through holes 66 are still present and a necessary part of the rehabilitation flexor 1. The rehabilitation flexor 1 retains many of the same properties and can be used in substantially the same manner as described above.

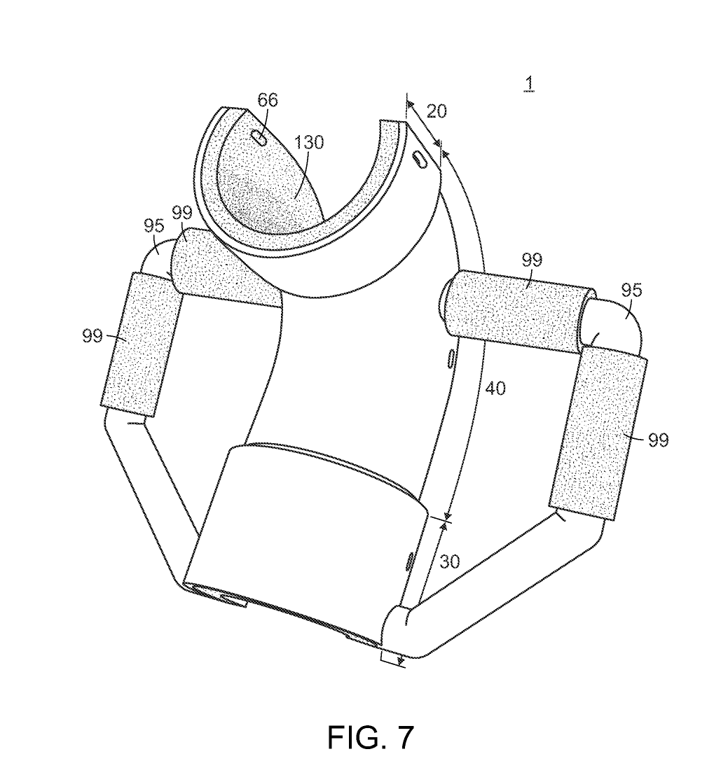

FIG. 7 shows a rear perspective view of the same alternate embodiment as described in FIG. 6. Here, one can see the center piece 10 has a top section 20, curved section 40, and a bottom section 30. Extending from each side of the curved section 40 is a handle bar 95 covered with a handle padding 99. Either of the substantially straight portions of the handle bar 95 may be used to manipulate the rehabilitation flexor 1.

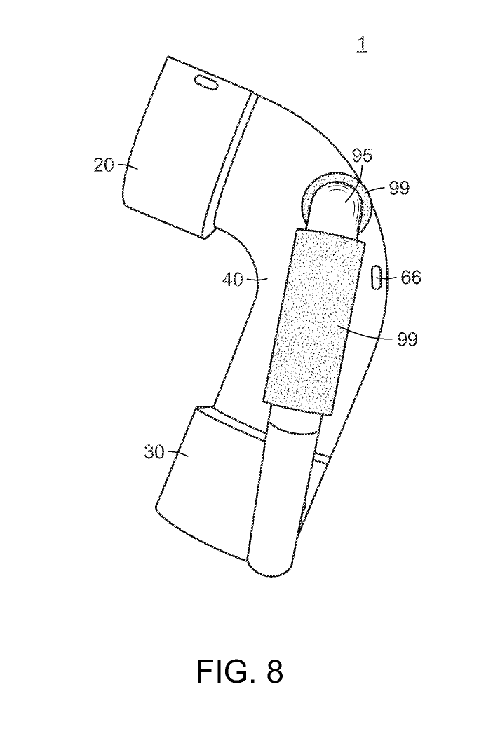

FIG. 8 shows a side view of the same alternate embodiment as described above. The rehabilitation flexor 1 has a top section 20 and a bottom section 30. Therebetween the curved section 40 longitudedly connects the sections forming a continual body. The handle bars 95 extend from this curved section 40 and are attached to the bottom section 30. The angles 220, 230 (see FIG. 4) are the same in this embodiment as well.

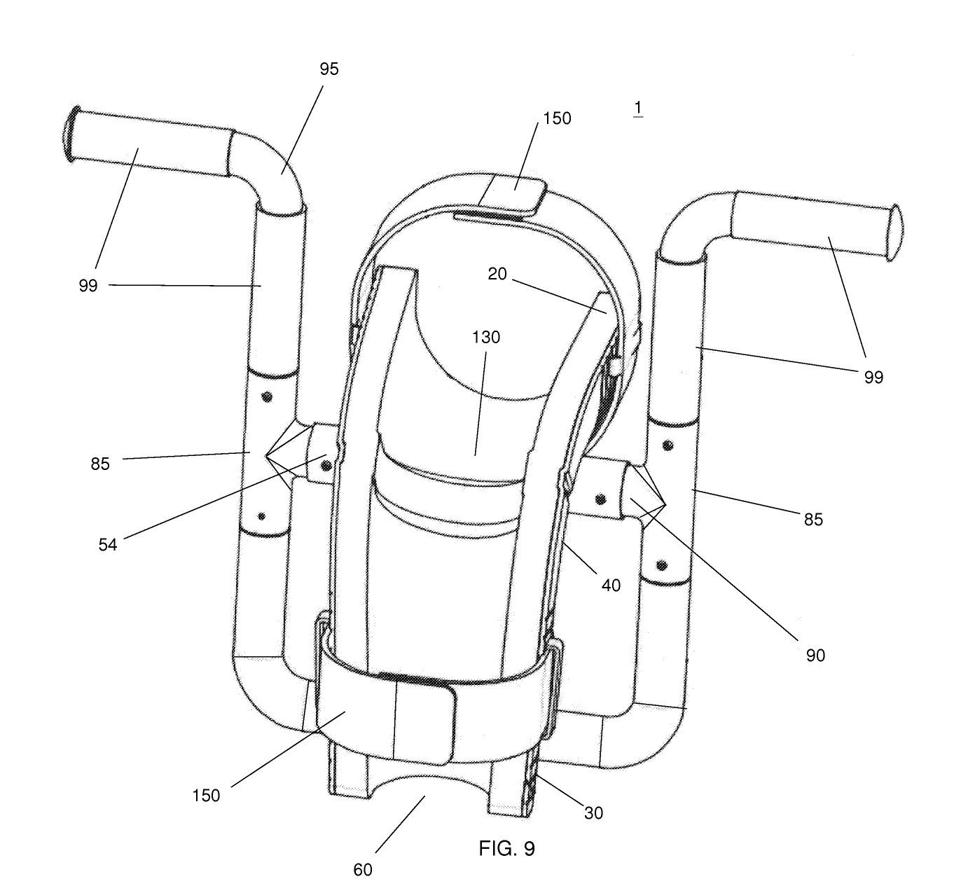

Referring now to FIG. 9, there is another embodiment of the present invention. Here, the rehabilitation flexor 1 generally has the features of the previously described embodiments.

The twisting assemblies 80 (see FIG. 1A) are in a slightly different orientation. This orientation provides for a potentially more desirable grip as the handle bar 95 is curved at the top at approximately a right, or 90°, angle. The handle bar covers 99 above and below this bend provide for a comfortable gripping area for a user to hold on to the rehabilitation flexor 1. The twisting assembly 80 also has a first receiving tube 54 and a second receiving tube 90. The second receiving tube 90 being an extension of the straight bar 85. These receiving tubes enable the joining of the handle bar sections to one another and to the rehabilitation device 1. There may be snaps, locks, latches, and the like or any combination thereof that enable the handle bars 95 to be removed completely or partially for storage or transportation purposes.

The center piece 10 (see FIG. 1A) bears the same general shape as previously described. There is a top section 20, a curved section 40, and a bottom section 30. There is a center piece opening 60 where the user's leg fits into the rehabilitation device 1. The interior of the center piece 10 is lined with padded covering 130 as described above and as shown in FIG. 6. In some instances, the padded covering 130 may extend above the center piece or may be longer or shorter than the center piece. Further, there are straps 150 that can be used to secure the rehabilitation device 1 to the appendage of the user. The number of straps 150 may vary but is preferably between 1-10 straps with there more preferably being 2-3 straps. The straps 150 are fully adjustable and may pass through the through holes 66 (see FIG. 6) or be positioned my other mechanisms such as brackets, loops, rivets, and the like or any combination thereof. The straps 150 may be held in place once their length has been adjusted for use by hook and loop fasteners, buckles, snaps, ties, crimps, and the like or any combination thereof.

The size and weight of the rehabilitation flexor 1 may vary according to specific needs. It is preferable that the top section, bottom section, and the curved section have similar diameters, ranging from 5 to 100 cm, with the preferred range of 10 to 30 cm. It is also preferred that the top section and bottom section have similar lengths, ranging from 3 to 50 cm, with a preferred range or 5 to 20 cm. The length of the straight bar may range from 20 to 150 cm, with the preferred range of 30 to 80 cm. The length of the handle bar may range from 5 to 50 cm, with the preferred range of 10 to 30 cm. The length of the connecting rods may range from 3 to 30 cm, with the preferred range of 5 to 20 cm. The overall weight of the rehabilitation flexor 1 is preferred to be within the range of 1 to 30 kg, with a more preferred range of 3 to 15 kg.

The rehabilitation flexor 1 disclosed in the current invention may be made from any kind of materials. Various components of the rehabilitation flexor may be made from the same or different materials. It is preferable that the top section, bottom section, and curved section are made from the same material that is rigid, durable, and strong, but that is not a requirement. The top section, bottom section, and curved section may be made from materials such as but not limited to: metal such as aluminum alloy, rubber, and plastic such as, but not limited to, polyethylene terephthalate (PET), polyethylene (PE), high-density polyethylene, polyvinyl chloride (PVC), polyvinylidene chloride (PVDC), low-density polyethylene (LDPE), polypropylene (PP), polystyrene (PS), high impact polystyrene (HIPS) and polycarbonate (PC), or some combination thereof. The preferred material is PVC. It is also preferable that the handle bars and the straight bars are made from the same material that is rigid, durable, and strong, but that is not a requirement. The handle bars and the straight bars may be made from materials such as but not limited to: metal such as aluminum alloy, rubber, and plastic such as, but not limited to, polyethylene terephthalate (PET), polyethylene (PE), high-density polyethylene, polyvinyl chloride (PVC), polyvinylidene chloride (PVDC), low-density polyethylene (LDPE), polypropylene (PP), polystyrene (PS), high impact polystyrene (HIPS) and polycarbonate (PC), or some combination thereof. The handle bar covers and the straight bar covers are preferably made from anti-slippery materials that are durable.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A rehabilitation flexor, comprising:
a center piece including a top section, and a curved section, the top section longitudedly connecting to the curved section, forming a continuous body partially surrounding a leg recess and having an interior, an exterior, and a center piece opening providing lateral access to the leg recess, wherein the leg recess is configured to have a contour that accommodates a human leg behind the knee; and
two twisting assemblies connected to the center piece.

2. The rehabilitation flexor of claim 1, wherein the center piece further comprises:
a bottom section longitudedly connected to the curved section at an opposite end to the top section, wherein
the bottom section is part of the continuous body partially surrounding the leg recess.

3. The rehabilitation flexor of claim 2, wherein
the top section and the bottom section are partial cylindrical structures that are longitudedly straight, and
the curved section is a partial cylindrical structures that is longitudedly curved.

4. The rehabilitation flexor of claim 3, wherein
the center piece opening allows a human leg to be laterally inserted into the leg recess.

5. The rehabilitation flexor of claim 1, wherein the center piece further comprises:
two connecting rods, wherein
each connecting rod attaches the twisting assembly to the center piece.

6. The rehabilitation flexor of claim 1, wherein
each twisting assembly comprises a straight bar and a handle bar connected to the straight bar.

7. The rehabilitation flexor of claim 6, wherein
moving the twisting assembly results in movement of the center piece.

8. The rehabilitation flexor of claim 1, further comprising:
center piece interior pads attached to the interior of the center piece.

9. The rehabilitation flexor of claim 8, wherein
the center piece has center piece edges aligning the center piece opening.

10. The rehabilitation flexor of claim 9, wherein
there are through holes on the center piece positioned along the center piece edges, and the through holes are paired one against another.

11. The rehabilitation flexor of claim 10, further comprising:
straps, each strap linking a pair of through holes positioned against each other.

12. The rehabilitation flexor of claim 6, wherein
each handle bar attaches to the straight bar with an angle, and the angle ranges from 110 to 160 degrees.

13. The rehabilitation flexor of claim 1, wherein
the connecting rods removably attach the twisting assemblies to the center piece.

14. The rehabilitation flexor of claim 1, wherein
the connecting rods permanently attach the twisting assemblies to the center piece.

15. The rehabilitation flexor of claim 1, wherein
there are handle bar covers covering the handle bar.

16. The rehabilitation flexor of claim 1, wherein
there are straight bar covers covering the straight bar.

17. A rehabilitation flexor, comprising:
a center piece including two connecting rods, a top section, a bottom section, and a curved section, the top section and the bottom section longitudedly connecting to the curved section, forming a continuous body partially surrounding a leg recess and having an interior, an exterior, and a center piece opening aligned by center piece opening edges, the center piece opening providing lateral access to the leg recess;
and two twisting assemblies, each twisting assembly having a straight bar connected to a handle bar with an angle,
wherein
the leg recess is configured to have a contour that accommodate a human leg behind the knee,
the top section and the bottom section are partial cylindrical structures that are longitudedly straight,
the curved section is a partial cylindrical structures that is longitudedly curved,
the center piece opening allows a human leg to be inserted into the leg recess,
there are center piece interior pads attached to the interior of the center piece,
there are through holes positioned along the center piece edges and the through holes are paired one against another,
there are handle bar covers covering the handle bars,
there are straight bar covers covering the straight bars,
each connecting rod removably attaches a straight bar of a twisting assembly to the center piece,
the center piece is mirror symmetric,
and the two twisting assemblies are mirror symmetric.

18. The rehabilitation flexor of claim 17, wherein the center piece opening aligns longitudedly along the top section, the curved section, and the bottom section.

19. The rehabilitation flexor of claim 17, wherein the center piece include two first receiving tube and the twisting assemblies include two second receiving tubes, the first receiving tubes and the second receiving tubes accommodate the connecting rods.

20. A rehabilitation flexor, comprising:
a center piece including at least a top section, a curved section, and a bottom section,
wherein the top section is longitudedly connected to the curved section and the bottom section is longitudedly connected to the opposite end of the curved section, forming a continuous body partially surrounding a leg recess and having an interior, an exterior, and a center piece opening providing lateral access to the leg recess,
wherein the leg recess has a padded covering and is configured to have a contour that accommodates a human leg behind the knee;
two twisting assemblies connected to the center piece, each twisting assembly a straight bar section and a handle bar section with at least one covering positioned over at least one of the straight or handle bar sections; and
at least two straps coupled to the center piece,
wherein the straps provide a mechanism of securement of the rehabilitation device to a human leg.
